(19) United States
(12) Patent Application Publication
(10) Pub. No.: US 2011/0239946 A1
(43) Pub. Date: Oct. 6, 2011

(54) Method of Manufacturing a Pet Dog

(76) Inventor: Dave Ogle, Lakewood, CA (US)

(21) Appl. No.: 12/752,991

(22) Filed: Apr. 1, 2010

(51) Int. Cl. A01K 29/00; B68G 7/00

(52) U.S. Cl. 119/28.5; 29/91.1

(57) ABSTRACT

A method for fabricating pet beds that are uniform in shape that is cost effective and rapidly completed. A plug is wrapped in several layers of foam or padding. Each layer of foam is coupled to each other, however the plug is not coupled to any of the foam layers itself. After the foam has been properly placed, the plug is removed and a spring set that is substantially shaped like the plug is inserted into its place. The foam and spring set are then enveloped within a mattress cover. The pet bed may be fabricated in a plurality of shapes using the same process including oval or elliptical, circular, triangle or wedge, and rectangular. Each shape may also be fabricated using the same process in a “flat” or “high back” configuration.

### BACKGROUND OF THE INVENTION

1. Field of the Invention

The invention relates to the field of production of beds for dogs or other pets and specifically to a method of production that allows high quality pet beds to be uniformly produced quickly at a reasonable cost of manufacture.

2. Description of the Prior Art

Pet or dog beds have long been made using a wide variety of methods and even a wider amount of different types of material. The most basic type of pet bed is simply a piece of foam molded into a specific shape and then covered with a cloth cover that is sized to fit the molded foam shape. These beds are very inexpensive to make and can made extremely fast using traditional assembly line techniques. A pet bed that is only made from foam however is typically not very durable and is easily damaged from even light use.

Other pet beds found in the art are made of rings or sections of different material such as canvas or polyester blends which are then stuffed with cotton, foam, or other suitable cushion material. While these pet beds are more durable than foam pet beds, they are much more expensive to make and due to their flexible or malleable forms, do not lend themselves to being sized and shaped to an exact standard or model.

Pet beds have also long been made ranging in size from extra small for small breeds such as Chihuahuas to extra large for large breeds such as Great Danes and the like. However the needs of a small pet to that of a large pet in terms of pet bedding are not the same. What may be suitable for a relatively small pet of ten pounds or less may not be suitable for a pet that is one hundred pounds or more. A larger pet requires more support and pet beds comprised of foam or pillows stuffed full of cotton are not sufficient for properly providing that support.

What is needed is a pet pet bed that provides high quality support to any breed of dog or pet that is easy and inexpensive to manufacture and that is fabricated to a universal or uniform standard.

### BRIEF SUMMARY OF THE INVENTION

A method of fabricating a pet bed is provided which includes providing a plug with a predetermined shape and disposing a circumferential cushion around the circumference of the plug. An interior mat and/or top cushion is then disposed over a top surface of the plug and coupled to the top surface of the circumferential cushion to form a core of the pet bed. The plug is then removed from the core of the pet bed and a cavity within the core is exposed. A plurality of springs are then inserted into the cavity and an exterior mat is coupled to the bottom surface of the circumferential cushion, sealing the springs inside of the pet bed.

It is preferred that the circumferential cushion that is disposed around the circumference of a plug is a plug frame wrapped around the circumference of the plug however an edge cushion may also be wrapped around and coupled to the circumference of the plug frame, wherein the top surface of the edge cushion is higher than that of the top surface of the plug frame.

Finally, a mattress cover may be used to envelop the core and make the pet bed more durable and atheistically pleasing. The mattress cover is then sewn or otherwise coupled to the circumferential edge of the exterior mat.

In one embodiment, the plurality of springs are that are inserted into the pet bed are comprised of a plurality of individual springs coupled together so to maintain substantially the same circumscribed outline of the removed plug.

In another embodiment, a cutout is defined within the edge cushion along a longitudinal surface of the core.

In yet another embodiment, the edge cushion that coupled around the circumference of the plug frame has a top surface that is flush with the top surface of the plug frame thus giving the pet bed a “flat” configuration.

In another embodiment, where disposing a plug frame around the circumference of the plug includes wrapping the plug frame around the circumference of the plug and coupling a pair of lateral surfaces of the plug frame together to encapsulate the plug.

Furthermore, coupling the edge cushion around the circumference of the plug frame includes in one particular embodiment wrapping the edge cushion around the circumference of the plug frame, coupling a pair of lateral surfaces of the edge cushion together, and coupling the interior surface of the edge cushion to the exterior surface of the plug frame to encapsulate the plug frame.

In separate embodiment, the invention provides a method of fabricating a pet bed which includes providing a plug of a predetermined shape and disposing a plug frame around the circumference of a plug. A pair of lateral surfaces of the plug frame are coupled together so as to encapsulate the plug while an interior mat is disposed over the plug to a top surface of the plug frame. A top cushion is then coupled to the top surface of the interior mat, thereby in conjunction with the plug frame, and the top cushion form a core of the pet bed. An edge cushion is then disposed around the circumference of the core by coupling an interior surface of the edge cushion to the exterior surface of the core and coupling a pair of lateral surfaces of the edge cushion together so as to encapsulate the core. The core and edge cushion are then inverted and the bottom surface of the plug is exposed. The plug is removed from the core and exposing a cavity which has the same circumscribed outline as the removed plug. A spring set with the same circumscribed outline as the plug is inserted into the cavity and an exterior mat is coupled to a bottom surface of the plug frame and the edge cushion. A cutout is defined within the edge cushion along a longitudinal edge of the core, both of which are then enveloped with a mattress cover.

Additionally, the current invention provides for a pet bed including a circumferential border portion, a pillow top portion supported by the border portion, and a spring set encapsulated within the pet bed and disposed in the middle of the circumferential border portion and beneath the pillow top portion. Additionally, a mattress cover may be included which envelops the circumferential border portion and the pillow top portion of the pet bed.

In one embodiment, the circumferential border portion and the spring set encapsulated within the pet bed are each comprised of two parallel longitudinal edges and rounded over at either ends with a constant radius of curvature.

In another embodiment, the circumferential border portion and the spring set encapsulated within the pet bed are each comprised of a circular edge with a constant radius.

In yet another embodiment, the circumferential border portion and the spring set encapsulated within the pet bed are each comprised of two edges at right angles to each other with a curved edge with a constant radius of curvature disposed there between.

In a final embodiment, the circumferential border portion and the spring set encapsulated within the pet bed are each comprised of a six-faced polyhedron all of whose faces are parallelograms lying in pairs of parallel planes.

While the apparatus and method has or will pet bedescripet bed for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims-under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a perspective view of the oval shaped embodiment of the pet bed fabricated by the illustrated invention.

FIG. 2 is an exploded view of the components of the pet bed of the pet bed shown in FIG. 1.

FIG. 3 is a perspective view of a plug used in the fabrication of the pet bed shown in FIG. 1 with a plug frame circumferentially wrapped around the plug in a step of the method of fabrication.

FIG. 4 is a perspective view of the plug of FIG. 3 fully encapsulated by the plug frame.

FIG. 5 is a perspective view of an internal mat being coupled to the top surface of the plug frame of FIGS. 3-4 and disposed over the plug.

FIG. 6 is a perspective view of a top cushion being coupled to the internal mat shown in FIG. 5 and thus forming a core of the pet bed shown in FIG. 1.

FIG. 7 is a perspective view of the core shown in FIG. 6 being wrapped circumferentially by an edge cushion.

FIG. 8 is a perspective view of the core fully encapsulated by the edge cushion and then inverted to expose the bottom surface of the plug.

FIG. 9 is a perspective view of the fabrication step where the plug is removed from the inverted pet bed and where a spring set substantially shaped like the removed plug is inserted into its place within the plug frame.

FIG. 10 is a perspective view of the inverted pet bed of FIG. 9 after the spring set has been fully inserted and encapsulated by the plug frame.

FIG. 11 is a perspective view of the inverted pet bed of FIG. 10 after an external mat has been coupled to the bottom surfaces of the plug frame and edge cushion and disposed over the spring set.

FIG. 12 is a perspective view of the pet bed after a cutout has been defined within the edge cushion but before a mattress cover has been disposed over the pet bed and then coupled to it as shown in FIG. 1.

FIG. 13 is a perspective view of an alternative “flat” embodiment of the pet bed fabricated by the illustrated invention.

FIG. 14 is a perspective view of the “flat” embodiment of the pet bed shown in FIG. 13 after a correspondingly shaped mattress cover has been disposed over the pet bed and then coupled to it.

FIG. 15 is a perspective view of an alternative embodiment of a pet bed fabricated by the illustrated above illustrated method but where the pet bed is substantially circular shaped.

FIG. 16 is a perspective view of an alternative embodiment of a pet bed fabricated by the illustrated above illustrated method where the pet bed is substantially wedge or triangular shaped.

FIG. 17 is a perspective view of an alternative embodiment of a pet bed fabricated by the illustrated above illustrated method where the pet bed is substantially rectangular shaped.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

The illustrated invention is a method of producing a pet bed, generally denoted with reference numeral 10, that is fast, inexpensive to produce, but which produces a pet bed which is made to a uniform standard. There are four main shapes in which the pet bed 10 may be produced, with each shape being in one of two different configurations, namely “high back” or “flat” as will be described below. However, it is to be expressly understood that the number of different configurations and the shapes provided for pet bed 10 are nearly unlimited and any configuration or shaped desired is to expressly be understood as falling within the scope of the invention.

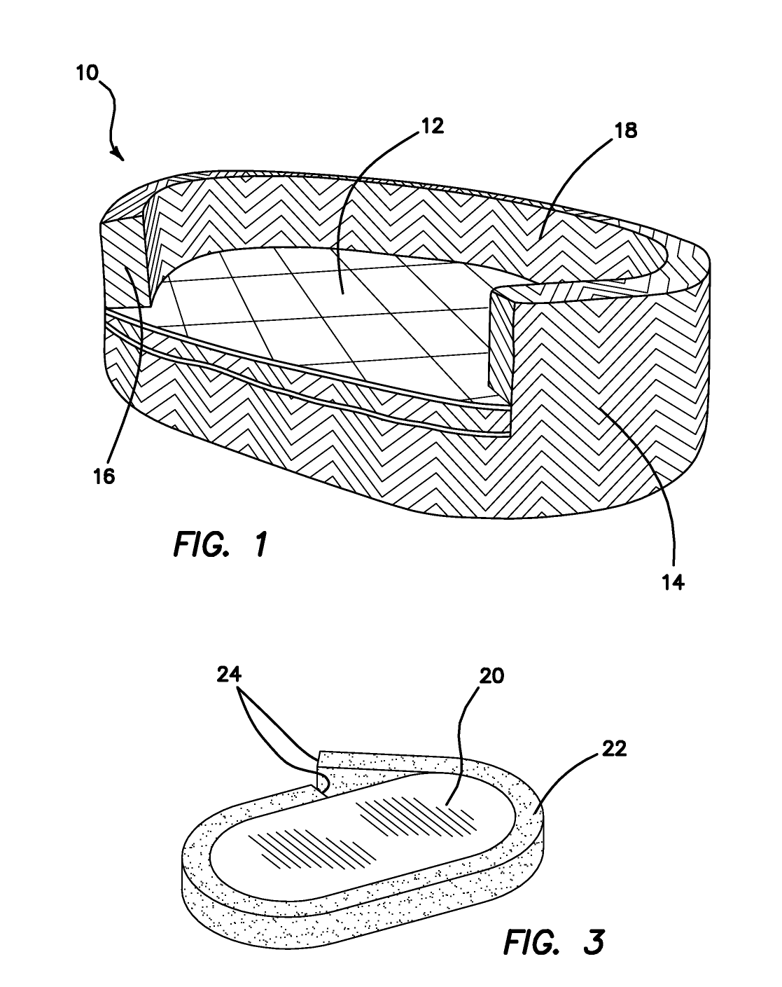

A first embodiment of a pet bed 10 produced by the illustrated invention can be seen in FIG. 1. The pet bed 10 in FIG. 1 is substantially oval in shape and comprises a flat pillow top 12 surrounded circumferentially by a border 14. In the particular embodiment shown in FIG. 1, the border 14 extends above the flat surface of the pillow top 12 into a high back 18. Like the border 14, the high back 18 is disposed about the circumference of the pillow top 12, except for along one of the longitudinal edges of the oval shape where a cutout 16 is defined. The cutout 16 is a gap or break in the high back 18 which allows a pet easier egress and ingress to the inner portion of the pet bed 10, namely the pillow top 12 and inner surface of the high back 18.

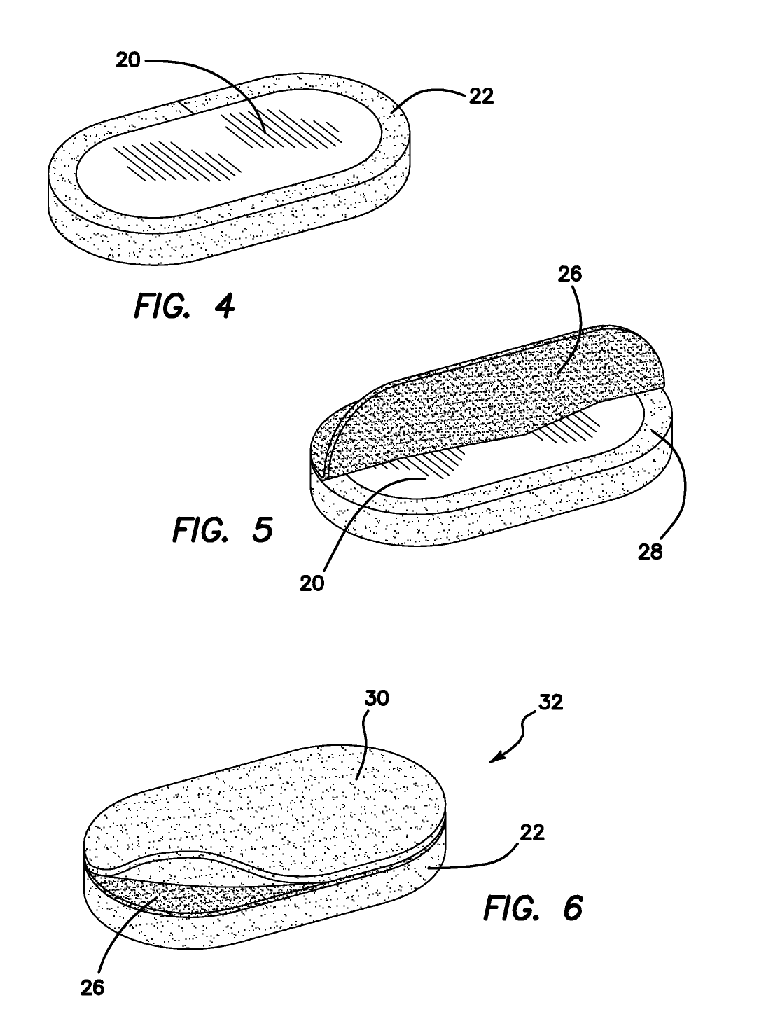

The first step of fabrication of the pet bed 10 seen in FIG. 1 can be seen by turning to FIG. 3 where a substantially oval shaped plug 20 is wrapped circumferentially by a plug frame 22. The plug 20 has a constant thickness and comprises two parallel longitudinal edges. Each of the ends of the plug 20 are rounded off with a constant radius of curvature, giving the plug 20 a constant symmetry along both its longitudinal and lateral axes. The plug frame 22 is preferably comprised of foam, however other malleable materials such as rubber or other types of padding now known or later devised may be used without departing from the original spirit and scope of the invention. The plug frame 22 is substantially in the shape of a parallelepiped, or is in other words a solid three dimensional six-faced polyhedron all of whose faces are parallelograms lying in pairs of parallel planes. The plug frame 22 includes two lateral ends 24 and is sufficiently long enough so that when one of its longitudinal faces is wrapped around the plug 20 as seen in FIG. 3, the lateral ends 24 meet at the same point around the circumference of the plug 20. A quick drying, water-based adhesive is applied to one or both lateral ends 24 which are then pressed together and allowed to dry to form a complete ring around the plug 20 as best seen in FIG. 4. It is important to note that any adhesives, glues, resins, or epoxies not described here but which are well known in the art may be used without departing from the original spirit and scope of the invention.

In the next fabrication step shown in FIG. 5, an internal mat 26 is placed over the plug 20 and surrounding plug frame 22. The internal mat 26 is sized and shaped to match the plug 20 and plug frame 22 combination upon which it is disposed and is preferably comprised of a soft composite fabric material suitable for use as a cushion or other padding. Adhesive is applied to the outer portion of the internal mat 26, specifically around the circumference of the internal mat 26 near the outside edge. The edge of the internal mat 26 is then pressed down against the top surface 28 of the plug frame 22 and allowed to dry. It is important to emphasize that no adhesive is ever applied to the plug 20, only to the plug frame 22.

In FIG. 6, the next fabrication step is shown which comprises a top cushion 30 being adhered to the top surface of the internal mat 26. The top cushion 30 is sized and shaped to match the plug 20 and plug frame 22 combination it is disposed upon and is preferably comprised of a soft malleable material such as foam or other similar material. Adhesive is applied to the entirety of the bottom surface of the top cushion 30 which is then pressed down upon the internal mat 26 beneath it. The top cushion 30 is what gives the pillow top 12 seen in FIG. 1 its shape and definition. After the adhesive has dried, a three layer combination of the plug frame 22, internal mat 26, and top cushion 30 is formed. This combination will herein after be collectively referred to as the “core” 32 seen in FIG. 6.

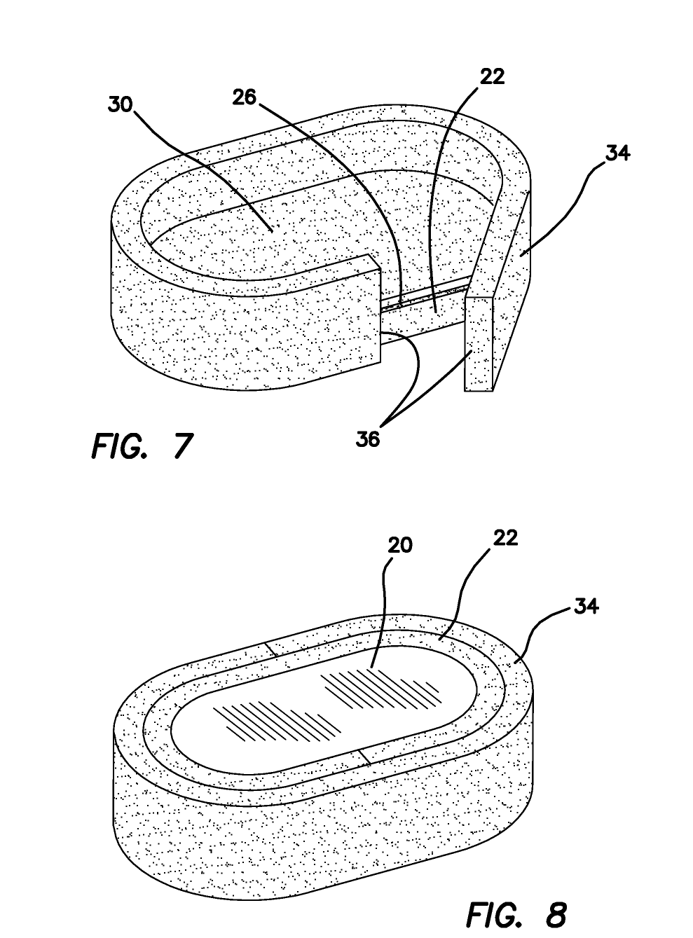

After the core 32 has been formed, an edge cushion 34 is circumferentially wrapped about it as seen in FIG. 7. The edge cushion 34 is comprised of the same foam material as the plug frame 22 and top cushion 30, and is substantially in the shape of a parallelepiped. The edge cushion 34 comprises two lateral ends 36 and is sufficiently long enough so that when one of its longitudinal faces is wrapped around the core 32 as seen in FIG. 7, the lateral ends 36 meet at the same point around the circumference of the core 32. A quick drying, water-based adhesive is applied to one or both lateral ends 36 which are then pressed together and allowed to dry to form a complete ring around the core 32.

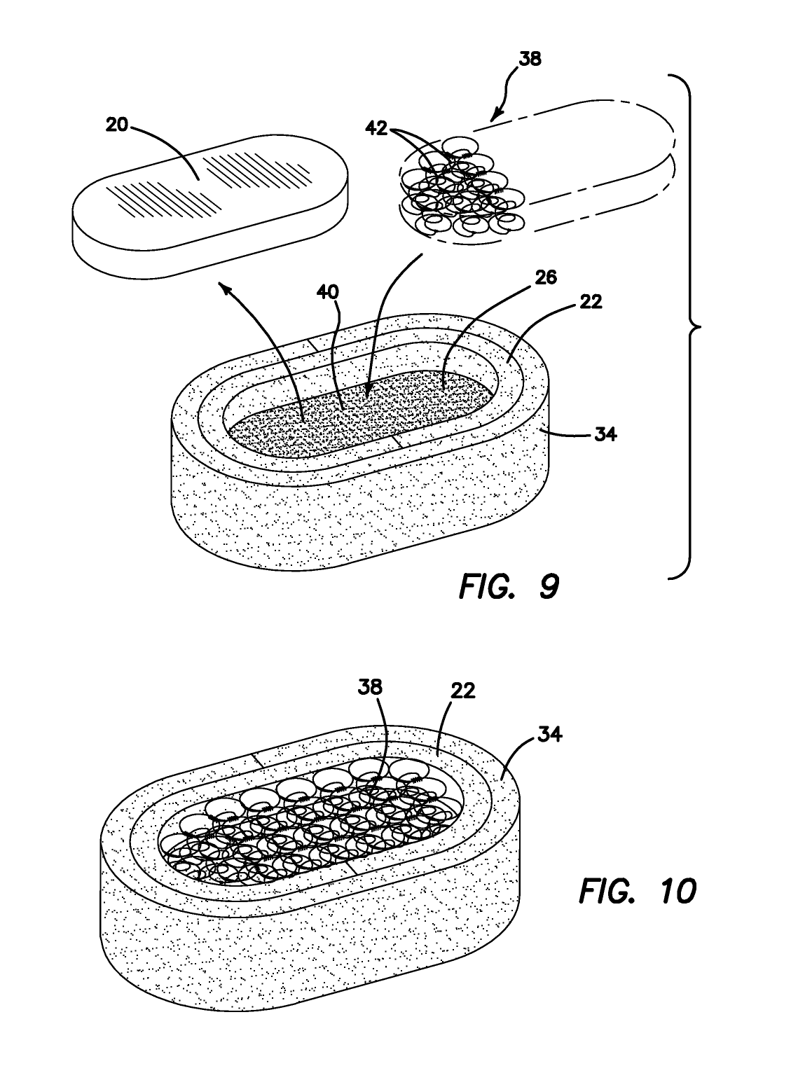

The edge cushion 34 and core 32 are then inverted which exposes the bottom surface of the plug 20 still within the plug frame 22 as seen in FIG. 8. The plug 20 is then removed from the plug frame 22, exposing the internal mat 26 beneath and leaving a cavity 40 having the same circumscribed outline as the formally inserted plug 20 as best seen in FIG. 9. A prefabricated spring set 38 also having the same or substantially similar circumscribed outline or envelope as the plug 20 as depicted in the broken line drawing of FIG. 9 is then inserted into the cavity 40 between the plug frame 22 and the internal mat 26. The spring set 38 is comprised of a predetermined plurality of individual springs 42 that are coupled together so as to substantially mimic and approximate or conform to the shape of the plug 20, thereby substantially filling the cavity 40 encapsulated by the plug frame 22 and providing support for internal mat 26. Spring set 38 may be specially fabricated as an interconnected plurality of springs with the desired outer envelope shape needed for the illustrated embodiment or may be cut to the desired envelope shape from a conventional prefabricated box spring set. When inserted, each spring 42 on the exterior of the spring set 38 is in tangential contact with the interior surface of the plug frame 22. Each spring 42 within the spring set 38 is approximately as long in its uncompressed state as the plug 20 is deep. In other words, in the illustrated embodiment when the spring set 38 is placed within the cavity 40 against the internal mat 26, the opposing ends of each of the springs 42 are flush with the bottom surface of the edge cushion 34 and the plug frame 22 as seen in FIG. 10. It is in this fashion that the plug 20 serves as a surrogate place holder for the spring set 38 until the various layers of cushioning or padding that are to surround the springs 42 may be properly assembled. By providing the ability to simply “drop in” the spring set 38 as a whole into the pet bed 10 within a single step, rather than inserting each spring 42 individually, dramatically reduces costs and time of production and results in a uniform product being produced. Use of the prefabricated spring set 38 also insures that each pet bed 10 produced by the above process is uniform in shape and form and that there are no discrepancies between each pet bed 10 made. However, it must be understood that it is entirely within the scope of the invention that uncompressed length of spring set 38 may also be sized to be slightly greater than the depth of plug frame 22, if desired, to provide for an crown mattress shape for internal mat 26.

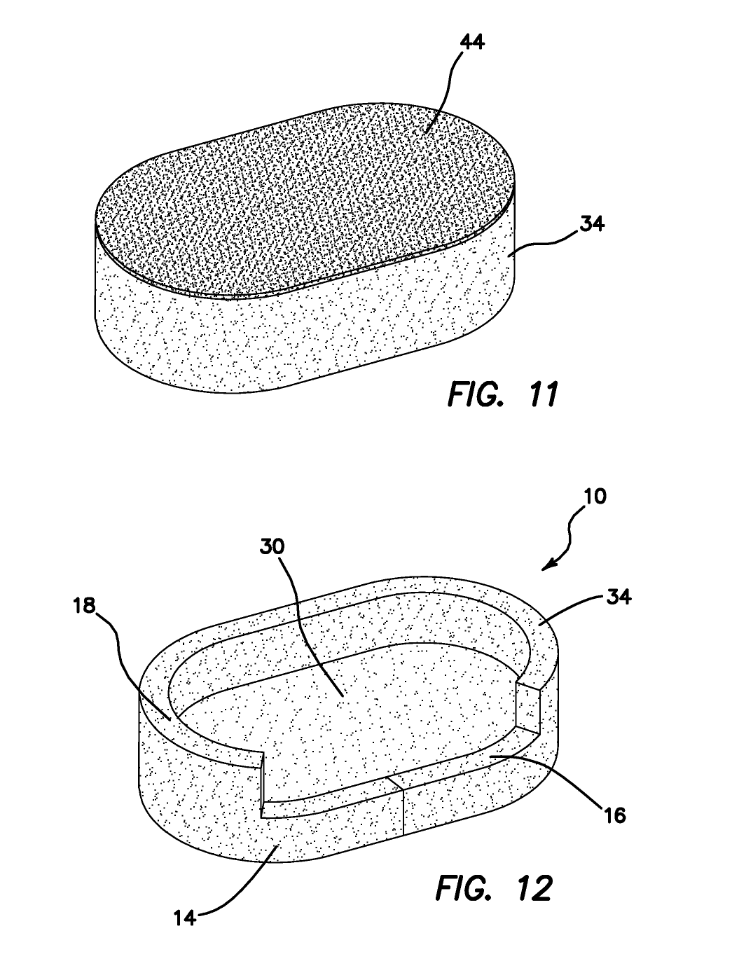

With the pet bed 10 still upturned, an exterior mat 44 has a thin layer of adhesive applied and is then pressed against the bottom surface of the edge cushion 34 as seen in FIG. 11. The exterior mat 44 is sized and shaped to fully cover the bottom surfaces of the edge cushion 34, the plug frame 22, and the spring set 38. With the exterior mat 44 in place, the spring set 38 is now firmly contained and encapsulated within the pet bed 10. The exterior mat 44 is also sufficiently sized and shaped so that its outer edge is flush with that of the edge cushion 34.

The pet bed 10 is then uprighted so that the top cushion 30 is exposed. A cutout 16 is then defined into the edge cushion 34 by a knife or other equivalent means along one of the longitudinal edges of the pet bed 10 at a predetermined position. The cutout 16 is defined from the top surface of the edge cushion 34 down to the level of the top cushion 30. In other words, the lowest portion of the cutout 16 is flush with the surface of the top cushion 30, thus giving the pet direct access to the top cushion 30 and spring set 38 contained beneath it. The cutout 16 also effectively divides the edge cushion 34 into an upper half and a lower half, the upper half, or high back 18, being disposed above the plane defined by the top cushion 30, the lower half, or border 14, being disposed beneath the plane defined by the top cushion 30 seen in FIG. 1. Alternatively, edge cushion 34 may have cutout 16 predefined in it by any method now known or later devised before edge cushion is affixed to core 32.

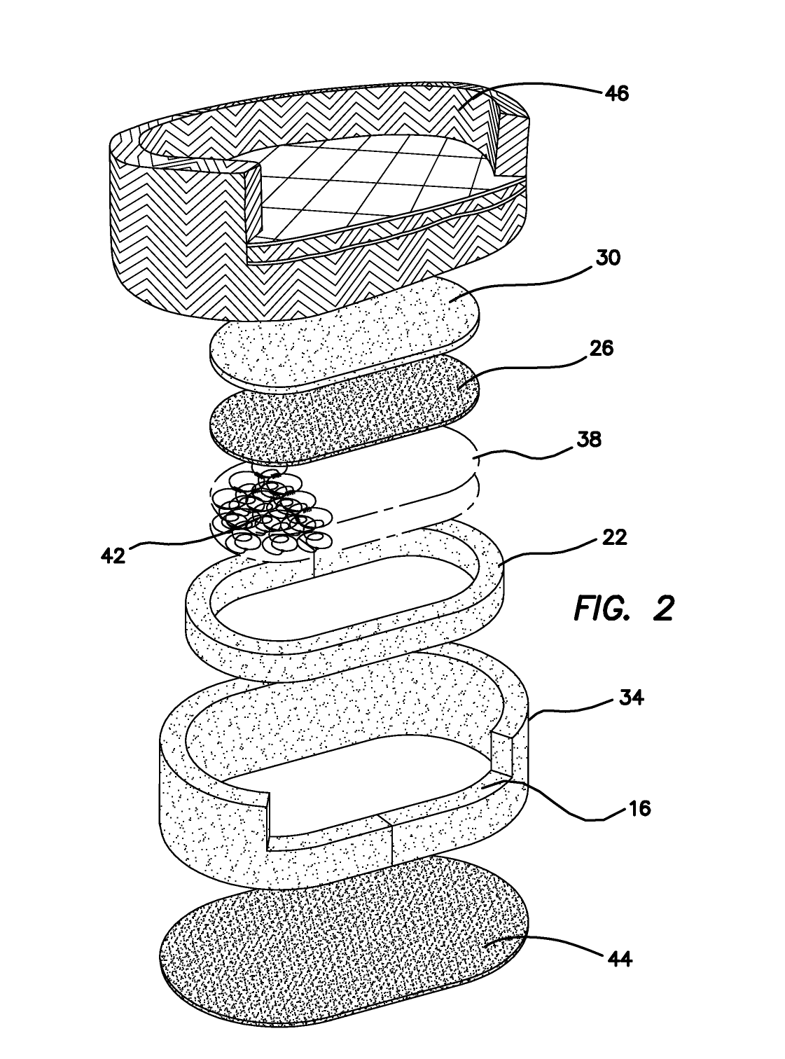

With the cutout 16 defined into the edge cushion 34 and with the material sculpted from the defining of the cutout 16 removed, the basic shape of the pet bed 10 is complete as can be seen in FIG. 12. In the final step, a prefabricated mattress cover 46 seen in FIG. 2 is slipped onto the pet bed 10. In the illustrated embodiment the mattress cover 46 is comprised of tough yet flexible cotton or cotton composite fabric well known in the art that is pre-cut and pre-sewn to substantially mimic and approximate or conform to the predetermined shape and contours of the pet bed 10. The mattress cover 46 is manipulated around the pet bed 10 until all of the exposed surfaces, except for that of the exterior mat 44 on the bottom of the pet bed 10, are enveloped. The lower edge of the mattress cover 46 is then stretched down to the exterior mat 44 and is then sewn circumferentially into the material. The pet bed 10 is now in its completed configuration seen in FIG. 1 and is ready for immediate use. It can also appreciated however that additional slip covers (not shown) or other materials may slipped around or otherwise disposed about the mattress cover 46 in order to give it a selected and changeable decorative appeal or increased durability without departing from the original spirit and scope of the invention.

A summary of the components used in the fabrication of the pet bed 10 may be had by turning to FIG. 2. Starting from the bottom, the exterior mat 44 which may be comprised of soft padding material or alternatively of more durable materials such as rubber, provides the contact point between the pet bed 10 and the surface on which the pet bed 10 is resting. Coupled to the outer edges of the exterior mat 44 is the edge cushion 34 with a cutout 16 defined along one of longitudinal sides. Also coupled to the exterior mat 44 and encapsulated within the edge cushion 34 is the plug frame 22. The plug frame 22 in turn encapsulates the spring set 38, which as described above, is substantially shaped the same as the plug 20 which was used during the fabrication process. Disposed over the spring set 38 and coupled to the plug frame 22 is the interior mat 26. Coupled to the interior mat 26 is the top cushion 30. The interior mat 26 serves as a barrier between the top cushion 30 and the spring set 38 and prevents any of the individual springs 42 from poking through into the top cushion 30 or otherwise providing an uneven or lumpy surface. Disposed around the entirety of the pet bed 10 including the top cushion 30 and edge cushion 34 and coupled to the exterior mat 44 is the mattress cover 46.

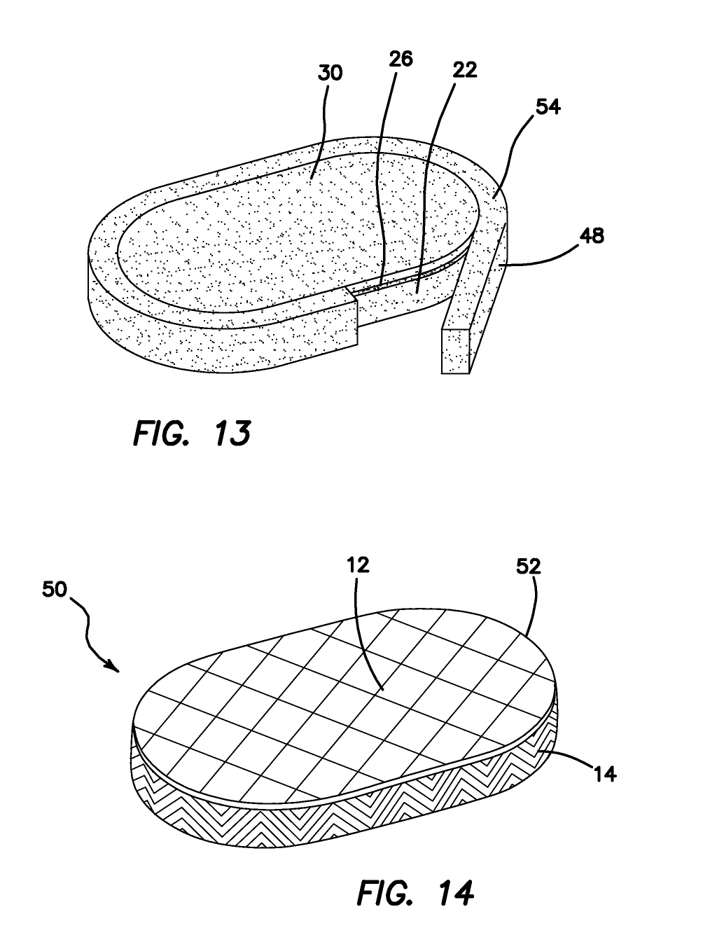

In another embodiment, a “flat” pet bed, generally denoted by reference numeral 50, may be fabricated without a high back portion as can be seen in FIG. 14. The steps of fabrication are identical to that of the previous embodiment shown in FIGS. 3-6, however instead of wrapping the edge cushion 34 circumferentially around the core as seen in FIG. 7, a reduced edge cushion 48 is wrapped around the core as seen in FIG. 13. The reduced edge cushion 48 is the same as the edge cushion 34 except for that it is the same height of the core itself. In other words, after the reduced edge cushion 48 has been circumferentially wrapped around and adhered to the core, a top surface 54 of the reduced edge cushion 48 is flush with that of the top cushion 30 as seen in FIG. 13. The remainder of the fabrication steps shown in FIGS. 8-12 are then carried out as disclosed above. In the final step, a prefabricated flat mattress cover 52 seen in FIG. 14 is slipped onto the pet bed 50. The mattress cover 52 is comprised of tough yet flexible cotton or cotton composite fabric well known in the art that is pre-cut and pre-sewn to substantially mimic and approximate or conform to the shape and contours of the pet pet bed 50. The mattress cover 52 is manipulated around the pet pet bed 50 until all of the exposed surfaces, except for that of the exterior mat 44 on the bottom of the pet bed 50, are enveloped. The lower edge of the mattress cover 52 is then stretched down to the exterior mat 44 and is then sewn circumferentially into the material. The pet bed 50 is now in its completed configuration seen in FIG. 14 and is ready for immediate use. It can also appreciated however that additional slip covers (not shown) or other materials may slipped around or otherwise disposed about the mattress cover 52 in order to give it more decorative appeal or increased durability without departing from the original spirit and scope of the invention.

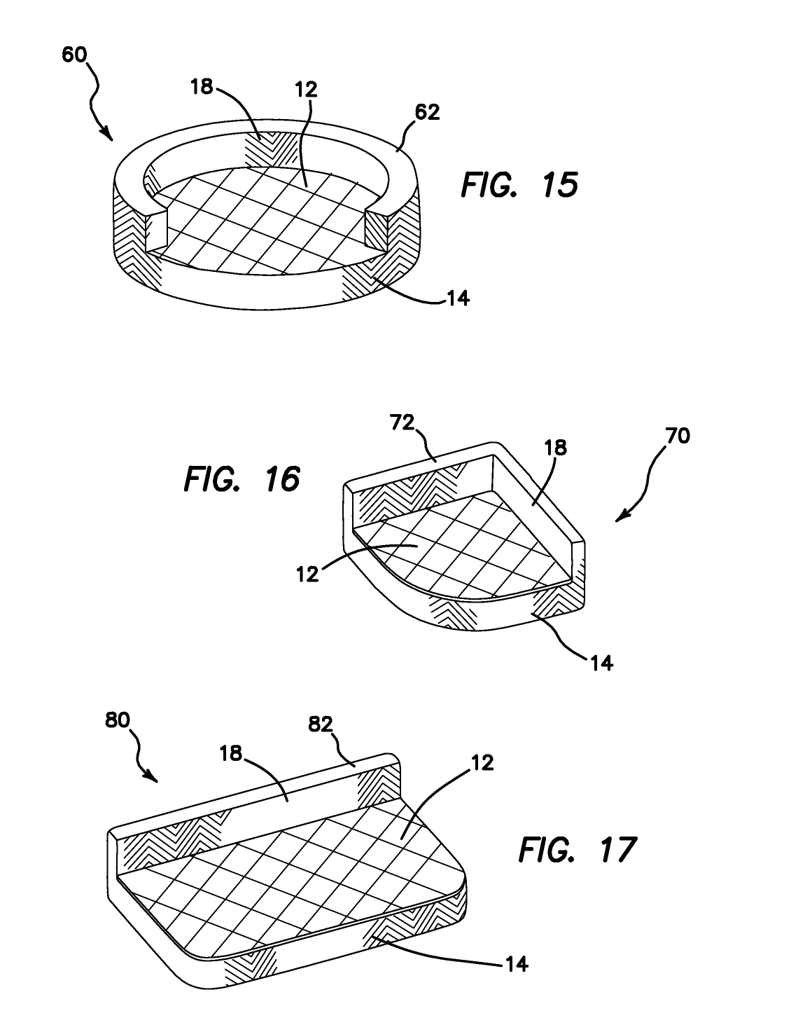

In another embodiment, the pet bed may be fabricated into a circular shape, generally denoted by reference numeral 60 as seen in FIG. 15. The circular pet bed 60 is fabricated in the same manner described above and shown in FIGS. 3-12, however the plug 20 which is used is substantially disk shaped. The disk plug (not shown) has a constant thickness and a constant radius, similar to that of the pillow top 12 shown in FIG. 15. Similarly, the spring set 38 used in the fabrication process to produce the circular embodiment shown in FIG. 15 is also substantially disk shaped and has the same circumscribed outline as the disk plug. The disk spring set (not shown) is comprised of a predetermined plurality of individual springs 42 that are coupled together so as to mimic and approximate the shape of the disk plug, thereby substantially filling in the cavity 40 encapsulated by the plug frame 22. When inserted, each spring 42 on the exterior of the spring set 38 is in tangential contact with the interior surface of the plug frame 22. Each spring 42 within the disk spring set is as long in its uncompressed state as the disk plug is deep. In other words, when the disk spring set is placed within the cavity 40 against the internal mat 26, the opposing ends of each of the springs 42 are flush with the bottom surface of the edge cushion 34 and the plug frame 22. Finally, a prefabricated circular mattress cover 62 seen in FIG. 15 is slipped onto the circular pet bed 60. The mattress cover 62 is comprised of tough yet flexible cotton or cotton composite fabric well known in the art that is pre-cut and pre-sewn to substantially mimic and approximate or conform to the shape and contours of the circular pet bed 60. The circular mattress cover 62 is manipulated around the circular pet bed 60 until all of the exposed surfaces, except for that of the exterior mat 44 on the bottom of the pet bed 60, are enveloped. The lower edge of the mattress cover 62 is then stretched down to the exterior mat 44 and is then sewn circumferentially into the material. The pet bed 60 is now in its completed configuration seen in FIG. 15 and is ready for immediate use. It is also to be expressly understood that a “flat” circular pet bed, that is, a circular pet bed without the high back portion 18, may also be fabricated using the same process described and shown above, which process is herein reinstated.

In another embodiment, the pet bed may be fabricated into a corner or triangular shape, generally denoted by reference numeral 70 as seen in FIG. 16. The corner pet bed 70 is fabricated in the same manner described above and shown in FIGS. 3-12, however the plug 20 which is used is substantially wedge shaped. The wedge plug (not shown) has a constant thickness and comprises two edges that are at right angles to each other with a curved edge with a constant radius of curvature disposed there between, similar to that of the pillow top 12 shown in FIG. 16. Similarly, the spring set 38 used in the fabrication process to produce the corner embodiment shown in FIG. 16 is also substantially wedge shaped and has the same circumscribed outline as the wedge plug. The wedge spring set (not shown) is comprised of a predetermined plurality of individual springs 42 that are coupled together so as to substantially mimic and approximate or conform to the shape of the wedge plug, thereby substantially filling in the cavity 40 encapsulated by the plug frame 22. When inserted, each spring 42 on the exterior of the spring set 38 is in tangential contact with the interior surface of the plug frame 22. Each spring 42 within the wedge spring set is as long in its uncompressed state as the wedge plug is deep. In other words, when the wedge spring set is placed within the cavity 40 against the internal mat 26, the opposing ends of each of the springs 42 are flush with the bottom surface of the edge cushion 34 and the plug frame 22. Finally, a prefabricated corner mattress cover 72 seen in FIG. 16 is slipped onto the corner pet bed 70. The mattress cover 72 is comprised of tough yet flexible cotton or cotton composite fabric well known in the art that is pre-cut and pre-sewn to substantially mimic and approximate or conform to the shape and contours of the corner pet bed 70. The corner mattress cover 72 is manipulated around the corner pet bed 70 until all of the exposed surfaces, except for that of the exterior mat 44 on the bottom of the pet bed 70, are enveloped. The lower edge of the mattress cover 72 is then stretched down to the exterior mat 44 and is then sewn circumferentially into the material. The pet bed 70 is now in its completed configuration seen in FIG. 16 and is ready for immediate use. It is also to be expressly understood that a “flat” corner pet bed, that is, a corner pet bed without the high back portion 18, may also be fabricated using the same process described and shown above, which process is herein reinstated.

In another embodiment, the pet bed may be fabricated into a rectangular shape, generally denoted by reference numeral 80 as seen in FIG. 17. The rectangular pet bed 80 is fabricated in the same manner described above and shown in FIGS. 3-12, however the plug 20 which is used is substantially rectangular or parallelepiped shaped. The rectangular plug (not shown) has a constant thickness and is a six-faced polyhedron all of whose faces are parallelograms lying in pairs of parallel planes, similar to that of the pillow top 12 shown in FIG. 17. Similarly, the spring set 38 used in the fabrication process to produce the rectangular embodiment shown in FIG. 17 is also substantially rectangular shaped and has the same circumscribed outline as the rectangular plug. The rectangular spring set (not shown) is comprised of a predetermined plurality of individual springs 42 that are coupled together so as to mimic and approximate the shape of the rectangular plug, thereby substantially filling in the cavity 40 encapsulated by the plug frame 22. When inserted, each spring 42 on the exterior of the spring set 38 is in tangential contact with the interior surface of the plug frame 22. Each spring 42 within the rectangular spring set is as long in its uncompressed state as the rectangular plug is deep. In other words, when the rectangular spring set is placed within the cavity 40 against the internal mat 26, the opposing ends of each of the springs 42 are flush with the bottom surface of the edge cushion 34 and the plug frame 22. Finally, a prefabricated rectangular mattress cover 82 seen in FIG. 17 is slipped onto the rectangular pet bed 80. The mattress cover 82 is comprised of tough yet flexible cotton or cotton composite fabric well known in the art that is pre-cut and pre-sewn to substantially mimic and approximate or conform to the shape and contours of the rectangular pet bed 80. The corner mattress cover 82 is manipulated around the rectangular pet bed 80 until all of the exposed surfaces, except for that of the exterior mat 44 on the bottom of the pet bed 80, are enveloped. The lower edge of the mattress cover 82 is then stretched down to the exterior mat 44 and is then sewn circumferentially into the material. The pet bed 80 is now in its completed configuration seen in FIG. 17 and is ready for immediate use. It is also to be expressly understood that a “flat” rectangular pet bed, that is, a rectangular pet bed without the high back portion 18, may also be fabricated using the same process described and shown above, which process is herein reinstated.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

For example, the pet bed may be fabricated into other shapes other than those described above using the same process disclosed above without departing from the original spirit and scope of the invention.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

I claim:

1. A method of fabricating a pet bed comprising:
providing a plug with a predetermined shape;
disposing a circumferential cushion around the circumference of the plug;
disposing an interior mat and/or top cushion over a top surface of the plug and coupling it to at least one top surface of the circumferential cushion to form a core of the pet bed;
removing the plug from the core of the pet bed and exposing a cavity within the core;
inserting a plurality of springs into the cavity left behind from the removal of the plug; and
coupling an exterior mat to the bottom surface of the circumferential cushion.

2. The method of claim 1 where disposing a circumferential cushion around the circumference of a plug comprises disposing at least one plug frame around the circumference of the plug.

3. The method of claim 2 further comprising coupling an edge cushion around the circumference of the plug frame, wherein a top surface of the edge cushion is higher than that of the top surface of the plug frame.

4. The method of claim 1 further comprising enveloping the core and circumferential cushion with a mattress cover.

5. The method of claim 1 where inserting a plurality of springs into the cavity left behind from the removal of the plug comprises inserting a spring set into the cavity, wherein the spring set is comprised of a plurality of individual springs coupled together so to maintain substantially the same circumscribed outline of the removed plug.

6. The method of claim 3 further comprising defining a cutout within the edge cushion along a longitudinal surface of the core.

7. The method of claim 1 further comprising coupling the mattress cover to the circumferential edge of the exterior mat.

8. The method of claim 2 further comprising coupling an edge cushion around the circumference of the plug frame, wherein a top surface of the edge cushion is flush with that of the top surface of the plug frame.

9. The method of claim 2 where disposing a plug frame around the circumference of the plug comprises wrapping the plug frame around the circumference of the plug and coupling a pair of lateral surfaces of the plug frame together to encapsulate the plug.

10. The method of claim 3 where coupling an edge cushion around the circumference of the plug frame comprises:
wrapping the edge cushion around the circumference of the plug frame;
coupling a pair of lateral surfaces of the edge cushion together; and
coupling the interior surface of the edge cushion to the exterior surface of the plug frame to encapsulate the plug frame.

11. The method of claim 2 where disposing an interior mat over a top surface of the plug and coupling it to at least one top surface of at least one circumferential cushion comprises coupling the interior mat to a top surface of the plug frame.

12. The method of claim 3 where coupling an exterior mat to the bottom surfaces of the circumferential cushions comprises coupling the exterior mat to the bottom surfaces of the plug frame and the edge cushion.

13. The method of claim 8 where coupling an edge cushion around the circumference of the plug frame comprises:
wrapping the edge cushion around the circumference of the plug frame;
coupling a pair of lateral surfaces of the edge cushion together; and
coupling the interior surface of the edge cushion to the exterior surface of the plug frame to encapsulate the plug frame.

14. A method of fabricating a pet bed comprising:
providing a plug of a predetermined shape;
disposing a plug frame around the circumference of a plug;
coupling a pair of lateral surfaces of the plug frame together so as to encapsulate the plug;
coupling an interior mat disposed over the plug to a top surface of the plug frame;
coupling a top cushion to a top surface of the interior mat, wherein the plug frame, interior mat, and top cushion form a core of the pet bed;
disposing an edge cushion around the circumference of the core;
coupling an interior surface of the edge cushion to the exterior surface of the core;
coupling a pair of lateral surfaces of the edge cushion together so as to encapsulate the core;
inverting the core and edge cushion and exposing a bottom surface of the plug;
removing the plug from the core and exposing a cavity within the core which has the same circumscribed outline as the removed plug;
inserting a spring set with the same circumscribed outline as the plug into the cavity;
coupling an exterior mat to a bottom surface of the plug frame and the edge cushion;
defining a cutout within the edge cushion along a longitudinal edge of the core; and
enveloping the core and edge cushion with a mattress cover.

15. A pet bed comprising:
a circumferential border portion;
a pillow top portion supported by the border portion; and
a spring set encapsulated within the pet bed and disposed in the middle of the circumferential border portion and beneath the pillow top portion.

16. The pet bed of claim 15 where the circumferential border portion and the spring set encapsulated within the pet bed and disposed in the middle of the circumferential border portion are each comprised of two parallel longitudinal edges and rounded over at either ends with a constant radius of curvature.

17. The pet bed of claim 15 where the circumferential border portion and the spring set encapsulated within the pet bed and disposed in the middle of the circumferential border portion are each comprised of a circular edge with a constant radius.

18. The pet bed of claim 15 where the circumferential border portion and the spring set encapsulated within the pet bed and disposed in the middle of the circumferential border portion are each comprised of two edges at right angles to each other with a curved edge with a constant radius of curvature disposed there between.

19. The pet bed of claim 15 where the circumferential border portion and the spring set encapsulated within the pet bed and disposed in the middle of the circumferential border portion are each comprised of a six-faced polyhedron all of whose faces are parallelograms lying in pairs of parallel planes.

20. The pet bed of claim 15 further comprising a mattress cover enveloping the circumferential border portion and the pillow top portion supported by the border portion.
